(19) United States
(12) Patent Application Publication
(10) Pub. No.: US 2025/0340096 A1
(43) Pub. Date: Nov. 6, 2025

(54) COOLING SYSTEM FOR THE CHARGING CABLE OF AN ELECTRIC VEHICLE

(71) Applicant: Aptiv Technologies AG, Schaffhausen (CH)

(72) Inventors: Jan WOLNY, Krakow (PL); Wojciech KLIMEK, Krakow (PL); Monika PIESZKA, Zygmuntowska (PL); Michal CIESZYNSKI, Krakow (PL); Pawel KOZAK, Krakow (PL)

(21) Appl. No.: 19/196,809

(22) Filed: May 2, 2025

(30) Foreign Application Priority Data
May 2, 2024 (EP) 24173961.4

(51) Int. Cl. B60H 1/00

(52) U.S. Cl. CPC B60H 1/00392

(57) ABSTRACT

The disclosure concerns a cable cooling system for cooling an embedded part of a battery charging cable of a battery-operated vehicle, the vehicle comprising an air conditioning system operated with a coolant fluid circuit that is configured for absorbing heat by phase changing expansion, such as a compressor operated air conditioning system. According to the disclosure, the cable cooling system comprises a cable cooling liquid that is circulated in a closed circuit for absorbing heat from the charging cable and discharging the heat toward the air conditioner coolant fluid, through a cable cooling heat exchanger that is incorporated within the air conditioner coolant fluid circuit so as to be cooled by the air conditioner coolant fluid circuit. Preferably, the cable cooling liquid is a non-dielectric liquid such as an ethylene-glycol solution, which enables a very efficient cooling with simple and standard components.

### CROSS-REFERENCE TO RELATED APPLICATION

This application claims the benefit of and priority to European Application No. 24173961.4 filed with the European Patent Office on May 2, 2024, the contents of which are incorporated by reference herein.

### TECHNICAL FIELD

The present disclosure relates to a system for cooling the charging cable of an electric vehicle and its rechargeable battery.

### BACKGROUND

Today, most cables used for charging electric vehicles do not have specific cooling features, which significantly limits their current carrying capacity and thus increases battery charging time. Additionally, current cooling solutions are cumbersome and a source of cost and complexity.

One aim of this disclosure is to overcome some or all of the disadvantages of the prior art. In particular, it is intended to propose a cooling system for such a charging cable that brings a better compromise between various constraints such as performance, compact packaging, reliability, simplicity of manufacturing, installation, and adaptation compared to an existing cable cooling solutions.

### SUMMARY

In some aspects, the techniques described herein relate to a cable cooling system for cooling an embedded part of a battery charging cable of a battery-operated vehicle having an air conditioning system operated with a coolant fluid circuit that is configured for absorbing heat by phase changing expansion, the cable cooling system including: a cable cooling heat exchanger that is incorporated within an air conditioner coolant fluid circuit so as to be cooled by the air conditioner coolant fluid circuit; and a cable cooling liquid that is circulated in a closed circuit of the cable cooling heat exchanger for absorbing heat from the charging cable and discharging the heat to the air conditioner coolant fluid, through the air conditioner coolant fluid circuit.

In some aspects, the techniques described herein relate to a method for cooling an embedded part of a battery charging cable of a battery-operated vehicle, the vehicle including an air conditioning system operated with a coolant fluid circuit that is configured for absorbing heat by phase changing expansion, such as a compressor operated air conditioning system, the method including cooling the charging cable with a cooling system having a cable cooling heat exchanger that is incorporated within an air conditioner coolant fluid circuit so as to be cooled by the air conditioner coolant fluid circuit and a cable cooling liquid that is circulated in a closed circuit for absorbing heat from the charging cable and discharging the heat to the air conditioner coolant fluid, through the air conditioner coolant fluid circuit.

### BRIEF DESCRIPTION OF THE DRAWINGS

Exemplary embodiments and functions of the present disclosure will be described in more detail in the following with reference to the drawings described below. In the various figures, similar or identical elements have the same reference numbers.

FIG. 1 is a schematic diagram that illustrates an example of a system for cooling the charging cable of an electric vehicle according to some embodiments.

FIG. 2a is a schematic diagram of a cooling liquid circuit of the system of FIG. 1 with two externally insulated tubular different insulated compartments that each immerse one non-insulated conductors according to some embodiments.

FIG. 2b is a perspective cross-section view of a tubular conductor of the cooling liquid circuit of FIG. 2a according to some embodiments.

FIG. 3 is a schematic diagram of a cooling liquid circuit of the system of FIG. 1 having two different insulated compartments that each immerse one non-insulated conductors according to some embodiments.

FIG. 4 is a schematic diagram of a cooling liquid circuit of the system of FIG. 1 having a single cooling compartment immersing two different insulated conductors according to some embodiments.

### DETAILED DESCRIPTION

In the present disclosure, it must be understood that the term “charging cable” is also intended as encompassing various devices of the embedded circuit that are related and connected to the conductors of this cable, from the charging port to the traction battery, such as the charging port, connection devices and terminals, and/or power transformation devices.

Thanks to these provisions, in this way the complexity of the cable heat rejection system is largely reduced since the climate control systems requires little modification to perform this additional role.

The refrigerant fluid from the cars climate control system is diverted into the cable heat exchanger. The refrigerant is expanded within or before entry into the cable heat exchanger to achieve a low refrigerant temperature. In the heat exchanger the fluid evaporates, efficiently cooling the liquid that flows in the charging cable. The refrigerant later is later compressed to a high pressure and condensed in the climate control condenser, preferably through the same compressor and circuit as for the refrigerant used by the vehicle cabin evaporator(s).

Multiple embodiments of invention are hereby envisioned, which comprise the optional features here disclosed, according to many of their feasible combinations.

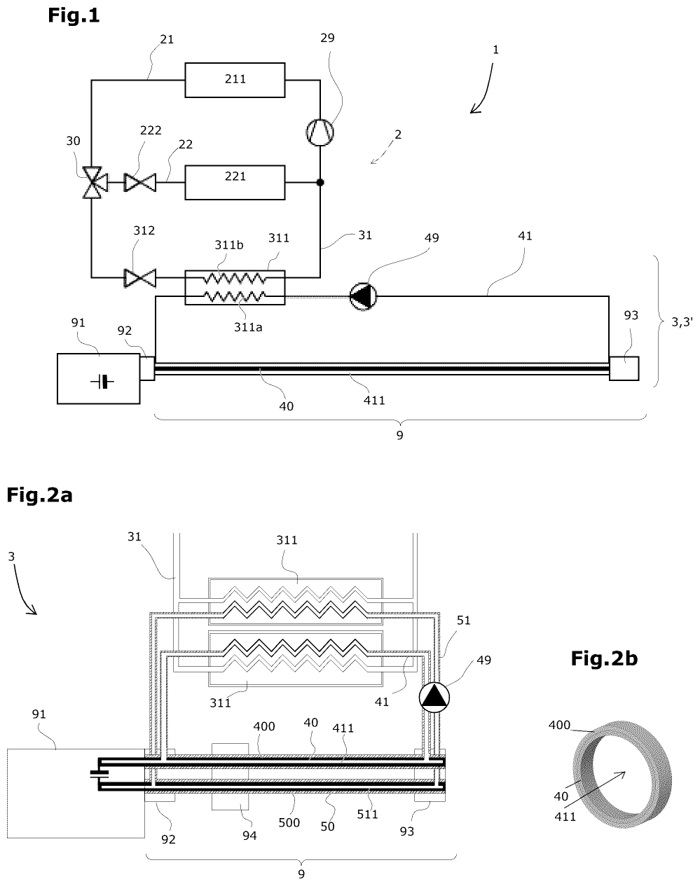

FIG. 1 illustrates a global cooling system 1 of a battery-operated vehicle, the battery 91 of which may be charged through a charging cable 9. In this example, this charging cable comprises a connexion box 92 and one or several electrical conductors 40 and a charging port 93 that are operatively connected together for supplying the battery with electrical energy from an external source (not shown) by a charging cord to be plugged into the charging cord 93.

A cable cooling system 3 comprises a cable cooling liquid that is circulated in a closed circuit 41 for absorbing heat from the charging cable 9 and discharging the heat toward the air conditioner coolant fluid 31, through a cable cooling heat exchanger 311.

FIG. 1 illustrates an air conditioning system 2 operated with a coolant fluid circuit that is configured for absorbing heat by phase changing expansion, here with a compressor 29 that increases the pressure of a refrigerant and circulates 31 it towards and through a condenser heat exchanger 211. It has a first cooling branch 22 that incorporates a cabin heat exchanger 221 arranged down stream of an expansion valve 222 for cooling the interior air of the vehicle. Such air conditioner system 2 is, for example, of a known type, and possibly a system of a type already used in an existing vehicle. An example of refrigerant fluid is R1234YF (2,3,3,3-tetrafluoropropene) fluid.

In this example, the cable cooling liquid is cooled by circulating through a first circuit 311a of the cable cooling heat exchanger 311, thanks to a second circuit 311b of the cable cooling heat exchanger 311 that is incorporated downstream of an expansion valve 312 within a branch of the vehicle air conditioning system 2, here in a second branch 31 of the air conditioner coolant fluid circuit that is parallel to the first cooling branch 22. A three-way valve 30 connects the first cooling branch 21 and the second cooling branch 31 to the condenser branch 21, so as to enable selecting as needed to refrigerate one or the other or both of the first and second cooling branch.

As can be seen, when compared with a standard known and industrialized air conditioner system, there are only few devices and parts to be added for building a charging cable cooling system according to the disclosure.

The cooling liquid circuit 41 is an unpressurized or moderately pressurized circuit, containing a cooling liquid that preferably needs no phase changing and has no or only small pressure differences. Its components 41, 49 therefore need only a quite simple technology, similar to most well-known components for liquid cooled thermal motors.

The second cooling branch 31 requires only standard ducts and two-way and three-way valves 30 and 312, similar to the well-known basic components of a standard air conditioner system. Even the cable cooling heat exchanger 311 may be derived from a known evaporation heat exchanger such as the cabin heat exchanger 221 or be built using similar technology.

Also, compared with a standard cabin air conditioning circuit, the air conditioning circuit 2 disclosed here uses standard technology and mainly standard components, which are potentially easily available in the industry of air-conditioner systems, such as the expansion valve 312 or the three-way valve 30.

In a first example of embodiment of the disclosure, FIGS. 2a and 2b illustrate with more details the cooling liquid circuit of FIG. 1. In this example, there are two different cooling liquid circuits 41 and 51, which are insulated from each other and from the rest of the vehicle. Both of these circuits 41, 51 are cooled within two first circuits of a same cable cooling heat exchanger 311, while it is also be envisioned to have them cooled by two different exchangers. Both circuits 41, 51 as illustrated here use a common pump 49 for circulation while in different embodiments two separate pumps may be used.

Each conductor 40, 50 is shaped as a metallic tubular conductor, as seen in detail in FIG. 2a. Electrically, such tubular conductors are externally insulated by an insulating layer 400, 500 respectively. They each define an internal compartment 411, 511, in which is circulated the cooling liquid of their respective circuit 41, 51.

As it is understood, the cooling liquid within such conductors is in direct contact with the metal of the conductor and able to exchange heat over a large area, much larger than if the liquid was surrounding a standard thread-like conductor. Moreover, external insulation is quite easy to provide directly around the external surface of the tube.

The rest of each of the cable cooling circuits 41, 51 is also electrically insulated from its environment, for example by using insulating hoses or conduits. In this example, each of these circuits 41, 51 is cooled in a separated and/or externally insulated part of the cable cooling heat exchanger 311. In this example, such parts of the cable cooling heat exchanger 311 are connected on two parallel branches of the air conditioner circuit 31, though various other configurations are also envsioned, such as in series. Preferentially the air conditioner cooling fluid of the air conditioner system 2 is an electrically insulator fluid, such as a fluid of R1234YF type. Preferentially, a direct metallic separation is then provided between the two circuit of each heat exchanger parts, thus with an optimal efficiency, without needing to have an air conditioner cooling circuit 31 to be electrically insulated by itself.

Other components of the charging cable 9, here a battery junction box 92 and the charging port 93 and a power transformation device 94, are also cooled by the cooling liquid circulated in one or both of the cooling liquid circuits 41, 51, directly or through an insulated heat exchange contact surface.

In this exemplary embodiment, it can be seen that it is possible to use a non-dielectric cooling liquid in these cooling liquid circuits 41, 51, for example, a solution of 50% ethylene-glycol and water, or any known cooling liquid. While it requires to build insulated circuits 41, 51, it also enables a very efficient conduction with the conductors 40, 50 and uses a liquid that more efficient than most dielectric cooling liquid, easier to find, cheaper to buy, and often less harmful for the environment.

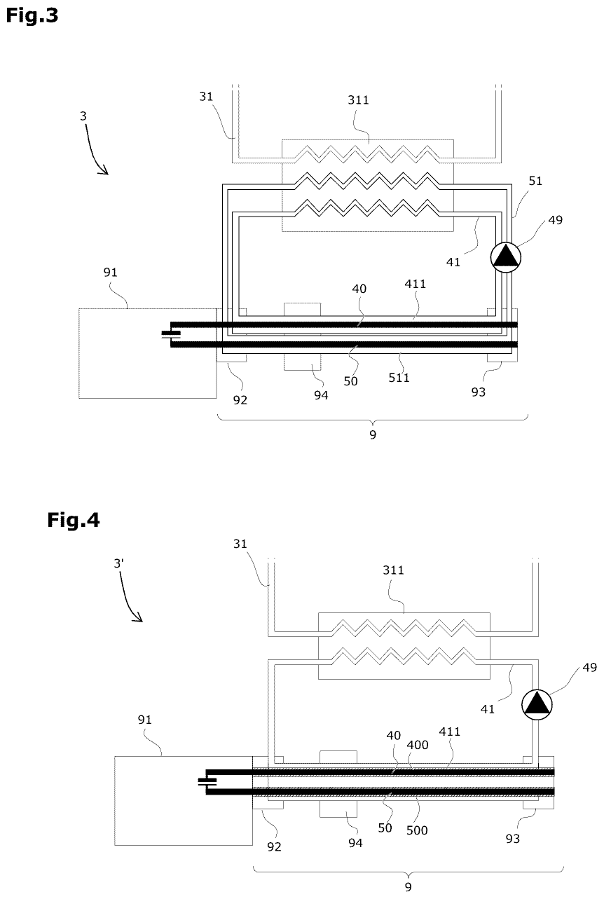

FIG. 3 and FIG. 4 illustrate with more details the cooling liquid circuit of FIG. 1 in variants of the embodiment of FIGS. 2a and 2b and will be described only in their differences.

In the example of FIG. 3, two electrical conductors 40, 50 are each directly immersed by cable cooling liquid in the internal compartment 411, 511 of a separated charging cable cooling insulated circuit 41, 51.

In the example of FIG. 4, two electrical conductors 40, 50 are each sheathed in an insulating layer 400, 500 and immersed by the same cooling liquid within a same internal compartment 411 of the cooling liquid circuit 41.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### Listing of Reference Numbers Used

1 global cooling system
2 air conditioning system
21 condenser branch
22 first cooling branch/cabin cooling branch
221 cabin heat exchanger
222 expansion valve of cabin branch
29 compressor
3 cable cooling system
30 three-way valve
31 second cooling branch/cable cooling branch
311 cable cooling heat exchanger/evaporator
311a first circuit of the cable cooling exchanger-cooling liquid
311b second circuit of the cable cooling exchanger-refrigerant fluid
312 expansion valve of the cable cooling branch
40, 50 electrical charging conductors of the charging cable
400, 500 insulating layers of the conductors
41,51 cable cooling liquid circuits
411, 511 conductor compartments of the cable cooling liquid circuits
49 circulation pump
9 charging cable
91 battery to be charged
92 connection/junction box
93 charging port
94 power transformation

1. A cable cooling system for cooling an embedded part of a battery charging cable of a battery-operated vehicle having an air conditioning system operated with a coolant fluid circuit that is configured for absorbing heat by phase changing expansion, the cable cooling system comprising:
a cable cooling heat exchanger that is incorporated within an air conditioner coolant fluid circuit so as to be cooled by the air conditioner coolant fluid circuit; and
a cable cooling liquid that is circulated in a closed circuit of the cable cooling heat exchanger for absorbing heat from the charging cable and discharging the heat to the air conditioner coolant fluid, through the air conditioner coolant fluid circuit.

2. The system according to claim 1, wherein the cable cooling fluid is a liquid-only fluid which is cooled by circulating through a first circuit of the cable cooling heat exchanger via a second circuit of the heat exchanger that is incorporated within a branch of the vehicle air conditioning system.

3. The system according to claim 2, wherein the branch of the vehicle air conditioning system is located downstream of an expansion valve.

4. The system according to claim 1, wherein the air conditioner coolant fluid circuit has a first cooling branch that incorporates a cabin heat exchanger arranged for cooling interior air of the vehicle, and in that the cable cooling heat exchanger is incorporated, downstream of an expansion valve, within a second cooling branch of the air conditioner coolant fluid circuit that is parallel to the first cooling branch.

5. The system according to claim 1, wherein the cable cooling liquid is a non-dielectric liquid and wherein it comprises one or several separated conductor cooling circuits that are insulated so as to insulate its cable cooling liquid from electrical contact with outside and from other conductor cooling circuits.

6. The system according to claim 5, wherein the cable cooling liquid is always in liquid phase.

7. The system according to claim 5, wherein only direct metallic separation is provided between the separated conductor cooling circuits within one or each of the cable cooling heat exchanger parts, the part of cable cooling heat exchanger being itself electrically insulated.

8. The system according to claim 1, wherein one or several conductors of the charging cable has an internal longitudinal cavity that forms a part of the charging cable cooling circuit in which the cooling liquid circulates in direct contact with the conductor and is electrically insulated on its external surface.

9. The system according to claim 8, wherein the internal longitudinal cavity has a tubular shape.

10. The system according to claim 1, wherein it comprises one or several insulated layers that are each closely applied on electrical conductors of one electrical phase of the charging cable, thereby insulating the conductor from the cable cooling liquid it is cooled by.

11. The system according to claim 10, wherein conductors of different electrical phases of the charging cable are cooled by a common charging cable cooling circuit.

12. A method for cooling an embedded part of a battery charging cable of a battery-operated vehicle, the vehicle comprising an air conditioning system operated with a coolant fluid circuit that is configured for absorbing heat by phase changing expansion, such as a compressor operated air conditioning system, the method comprising cooling the charging cable with a cooling system having a cable cooling heat exchanger that is incorporated within an air conditioner coolant fluid circuit so as to be cooled by the air conditioner coolant fluid circuit and a cable cooling liquid that is circulated in a closed circuit for absorbing heat from the charging cable and discharging the heat to the air conditioner coolant fluid, through the air conditioner coolant fluid circuit.
